(19) United States
(12) Patent Application Publication
(10) Pub. No.: US 2025/0321734 A1
(43) Pub. Date: Oct. 16, 2025

(54) FLEXIBLE INTEGRATION PROJECT DEPLOYMENT MODEL

(71) Applicant: Oracle International Corporation, Redwood Shores, CA (US)

(72) Inventors: Greg Gravenites, Littleton, CO (US); Gregory Mueller Cole, Aptos, CA (US); Rajan Modi, Highlands Ranch, CO (US); Arif Rafique, Parker, CO (US); Antony James Reynolds, Colorado Springs, CO (US)

(73) Assignee: Oracle International Corporation, Redwood Shores, CA (US)

(21) Appl. No.: 18/632,098

(22) Filed: Apr. 10, 2024

(51) Int. Cl. G06F 8/77; G06F 8/65

(52) U.S. Cl. CPC G06F 8/77; G06F 8/65

(57) ABSTRACT

Techniques are described for selecting an integration to be transmitted to a target system. An example method can include maintaining a project that includes a first integration associated with a first revision identifier. The method can further include obtaining information that identifies a revision has been made to the first integration. The method can further include updating the first revision identifier. The method can further include determining, that the first integration is to be transmitted to a target computing system based at least in part on the updated first revision identifier. The method can further include generating a container image that stores the first integration in accordance with a determination that the first integration is to be transmitted to the target computing system for use in the project. The method can further include transmitting, the container image to the target computing system.

### BACKGROUND

A cloud service provider (CSP) can provide multiple cloud services to subscribing customers. In some instances, a customer of the CSP can develop and/or manage software tools deployed by the CSP. In time, the customer may wish to update the software tools to either add or revise features of the software tools. However, there are challenges with updating software tools that rely on various CSP resources at different states.

### BRIEF SUMMARY

A cloud services provider (CSP) can develop a software solution for a software issue at a target system. The software solution can include a project that includes a collection of assets used to address the software issue. An asset can include an integration, which is an executable script used to address the software issue. Each integration can be labeled with a revision identifier to indicate a current version of the integration. In some instances, to update a software solution at the target system, it may only be necessary to revise one or more integrations. Each revised integration can be labeled with an updated revision indicator. The integration labels can indicate whether the target system needs to disable a portion install the corresponding integrations.

Techniques are described herein for identifying a revised integration to be deployed from one computing system to another computing system. In one embodiment, an example method can include maintaining a project for a target computing system. The project can include a first integration and a second integration. The first integration can include a first revision identifier and the second integration can include a second revision identifier.

The method can further include obtaining information that identifies a revision has been made to the first integration.

The method can further include updating the first revision identifier based at least in part on the revision to the first integration.

The method can further include determining whether the first integration is to be transmitted to the target computing system for use in the project based at least in part on the updated first revision identifier.

The method can further include generating a container image that stores the first integration in accordance with a determination that the first integration is to be transmitted to the target computing system for use in the project.

The method can further include transmitting the container image comprising the first integration with the updated first revision identifier to the target computing system for implementation within the project of the target computing system.

Another embodiment can include a computing system. The computing system can include one or more processors and one or more computer-readable media having stored thereon a set of instructions that, when executed, cause the one or more processors to maintain a project for a target computing system. The project can include a first integration and a second integration. The first integration comprises a first revision identifier and the second integration comprises a second revision identifier.

The instructions, that when executed, can further cause the one or more processors to obtain information that identifies a revision have been made to the first integration.

The instructions, that when executed, can further cause the one or more processors to update the first revision identifier based at least in part on the revision to the first integration.

The instructions, that when executed, can further cause the one or more processors to determine whether the first integration is to be transmitted to the target computing system for use in the project based at least in part on the updated first revision identifier.

The instructions, that when executed, can further cause the one or more processors to generate a container image that stores the first integration in accordance with a determination that the first integration is to be transmitted to the target computing system for use in the project.

The instructions, that when executed, can further cause the one or more processors to transmit the container image comprising the first integration with the updated first revision identifier to the target computing system for implementation within the project of the target computing system.

Another embodiment can include One or more non-transitory computer-readable media having stored thereon a set of instructions that, when executed by one or more processors of a computing system, cause the one or more processors to maintain a project for a target computing system. The project can include a first integration and a second integration. The first integration comprises a first revision identifier and the second integration comprises a second revision identifier.

The instructions, that when executed, can further cause the one or more processors to obtain information that identifies a revision has been made to the first integration.

The instructions, that when executed, can further cause the one or more processors to update the first revision identifier based at least in part on the revision to the first integration.

The instructions, that when executed, can further cause the one or more processors to determine whether the first integration is to be transmitted to the target computing system for use in the project based at least in part on the updated first revision identifier.

The instructions, that when executed, can further cause the one or more processors to generate a container image that stores the first integration in accordance with a determination that the first integration is to be transmitted to the target computing system for use in the project.

The instructions, that when executed, can further cause the one or more processors to. transmit the container image comprising the first integration with the updated first revision identifier to the target computing system for implementation within the project of the target computing system.

### BRIEF DESCRIPTION OF THE DRAWINGS

FIG. 1 is an illustration of an example system for generating a project, according to one or more embodiments.

FIG. 2 is an illustration of an example graphical user interface (GUI) for transmitting integrations, according to one or more embodiments.

FIG. 3 is an illustration of an example GUI timeline, according to one or more embodiments.

FIG. 4 is an illustration of an example GUI timeline, according to one or more embodiments.

FIG. 5 is a signaling diagram for project deployment, according to one or more embodiments.

FIG. 6 is an illustration of an example GUI timeline, according to one or more embodiments.

FIG. 7 is an illustration of an example project, according to one or more embodiments.

FIG. 8 is an illustration for a process for storing an accelerator in a store, according to one or more embodiments.

FIG. 9 is an illustration of an example table for project type and accessibility with respect to behavior, according to one or more embodiments.

FIG. 10 is a process flow for generating a project file, according to one or embodiments.

FIG. 11 is a block diagram illustrating one pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating another pattern for implementing a cloud infrastructure as a service system, according to at least one embodiment.

FIG. 14 is a block diagram illustrating another pattern for implementing a cloud infrastructure as a service system, according to at least one embodiment.

FIG. 15 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

A cloud services provider (CSP) can support a customer's software infrastructure by either allowing the customer to use the CSP's infrastructure or developing software for the customer. In many instances, a customer can adopt software-as-a-service (SaaS) solutions, in which the customer can use tools to manage particular aspects of their operation without having to support the solutions internally.

From time to time, a CSP customer may request a software solution from the CSP. The customer can be a third party that is the end user for the software. For example, the customer may have a customer relation management (CRM) system and an accounting system. The customer may ask the CSP for a solution that enables the CRM system to communicate with the accounting system. The software solution may be a new solution or an update of a previously provided solution. Based on a customer's needs, the CSP can develop a software solution in the form of a project. A project can include various attributes, such as type, origin, accessibility, a revision identifier, keyword, documentation link, and/or a collection of assets. A developed project can be a project that is to be deployed to a target system. A recipe project can be a project that has been generated using the CSP's best practices. An accelerator project can be a project that is to be deployed to a CSP store for future consumption by an undetermined end user. In some embodiments, the project can include a collection of assets that can be activated and monitored by a single entity (e.g., a source system) during a design phase. An asset can include an integration, a connection, a library, and/or a link. An integration can be an executable script. A connection can include interface software, such as an application programming interface (API), a library can include a collection of routines or sub-routines, and a link can be a link to an external source. The project can provide a set of operations (e.g., activate, regenerate, validate, export, and clone) across the collection of assets. The project can be self-contained during the design phase, such that the assets associated with one project are not shared with another project. Furthermore, one asset within one project can use another asset within the same project. However, in some examples, an asset in one project may not be able to use an asset in another project. An asset can include, for example, an integration, where the integration can be an executable script. In some examples, an executable script in one project may not be able to access an executable script from another project.

The project can include, for example, a set of integrations, where the integrations permit one customer system (e.g., CRM system) to exchange data with another customer system (e.g., accounting system). The CSP can change one or more of the integrations to support the customer's request. Once the relevant aspects of the project are set, the CSP can compress the project and transmit the updated project to the customer.

In general, developers can use various techniques to develop and deliver software solutions to clients. One technique is a continuous integration/continuous deployment (CI/CD) technique. A CI/CD technique can involve automating the building, testing, and development of a software solution. However, an atomic delivery of related assets via CI/CD may not be supported. Another issue that can occur is that not all of the assets of the project are updated/added at the same time, and therefore redundant aspects of the project are also included in the updated project. An asset can include, for example, a database, a service, or other aspect of the computing system.

During an update at the customer's computing system, one or more endpoints of the customer's computing system may need to be disabled. In some examples, an endpoint may be accessible by specific coordinates (e.g., a uniform resource locator (URL) that provides a location of a resource on a server, or the like). For example, the customer's computing system may use an application programming interface (API) endpoint such as https://api.example.com. This endpoint may permit an application to call an integration (e.g., an executable script). If the integration is being replaced as part of an updating process, then the endpoint may need to be disabled to prevent an application from calling the integration. In another example, the API endpoint (https://api.example1.com) used to call the integration may be getting switched to another endpoint (e.g., https://api.example2.com), and therefore https://api.example1.com may need to be disabled.

In some instances, the update process may replace some integrations at the customer's computing system, but leave other integrations as is. In these instances, the endpoints that are related to the integrations to be replaced may need to be disabled. In a conventional updating process, even the endpoints associated with integrations that are not being replaced may be shutdown. Therefore, an endpoint (e.g., https://api.example.com/administrator) associated with an integration that is not being replaced may also need to be shutdown. This can be cumbersome for the customer's computing system, as even portions (e.g., assets) of the computing system that are not being updated with new integrations may have their endpoints shutdown.

Another issue that can occur is that the CSP may have multiple users working on updating different portions of the project. In many instances, one user working on one portion of the project may not be communicating with another user working on a different portion of the project. This may become problematic, as each user may need to update the same integration. Additionally, the group of users that created the original project may be different from the group of users that are working on the updated project. In each of the above scenarios, a user may be, for example, unable to recognize whether a particular integration is an original integration or an updated integrated script. Conventional systems have relied upon version identifiers for projects. For example, if a project included two integrations and one of the integrations was updated, then the project version identifier would be updated to indicate that at least one integration has been updated. Using this method, however, does not permit an indication as to which integration has been updated. This can lead to confusion as to whether an integration has been updated without a thorough and time-consuming analysis of each integration.

Embodiments described herein address the above-referenced issues, by providing techniques (e.g., methods, and/or devices) for allowing a developer to differentiate portions of a project that have changed from portions of the project that have not changed. The techniques can further permit the CSP to selectively package integrations into a project, and transmit the project to the customer. Therefore, the customer can receive a project that only includes updates to the portions of the project that have changed. The techniques further can be used to identify integration versions using revision identifiers. The revision identifiers can be values that describe/identify a version of a resource (e.g., an integration). Each integration can be associated with metadata that includes a revision identifier. Each time that a computing system creates a copy of a project, the computing system can iteratively amend the metadata to include an initial integration value (e.g., 0). Each time that a user changes the integration and saves the changes, the computing system can change the integration value. For example, the computing system can increment the integration value by 1 each time that an integration has been saved. The techniques described herein further permit the selection of integrations based on the revision identifier. Therefore, rather than analyzing an integration to determine the version, the revision identifiers can be used to determine the version. In this way, the integrations that are selected for use in a project (e.g., in some instances, the integrations transmitted to a customer) can be the desired version.

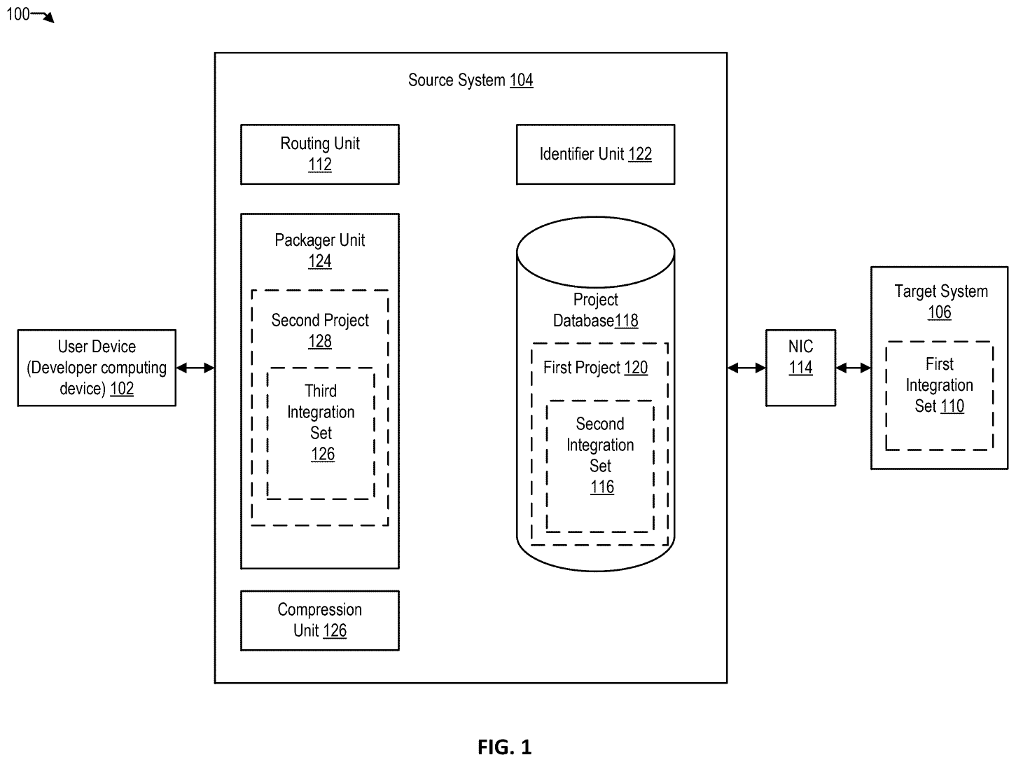

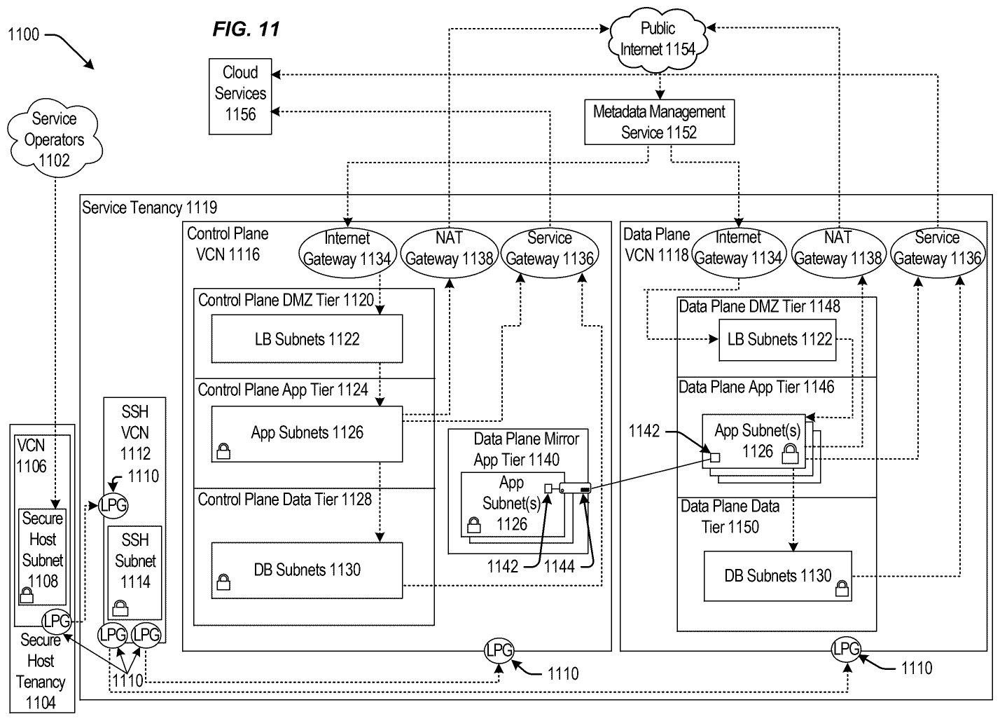

FIG. 1 is an illustration of an example system for generating a project, according to one or more embodiments. A user device 102 (e.g., a tablet, laptop, or a personal computer) can be in communication with a source system 104 (e.g., a CSP computing system) via a first communication network (e.g., local area network (LAN, wide area network (WAN). The source computing system 104 can be in communication with a target system 106 via a second communication network (e.g., LAN, WAN). The user device 102 can be a computing device used by a user to access the CSP's resources on the source system 104 and develop software. In some embodiments, the source system 104 can be a development environment or part of a development environment. The target system 106 can be a customer's computing system. In some embodiments, the target system 106 can be a product environment or part of a product environment. The source system 104 can be implemented by one or more architectures described in FIGS. 11-15.

From time to time, the customer may make a request to the CSP to develop a software solution. The solution may be a novel solution, or the solution may be an update of a previously developed solution. For example, the customer may be an international customer that has a CRM system in one region and a separate client information database in another region. The customer may ask the CSP for a solution for populating the CRM with the information from the client information database. In order to develop the solution, the source system 104 may retrieve integrations from the target system 106. For example, the source system 104 may retrieve a copy of the first integration set 110. The source system 104 may include routing unit 112 that can configure a network interface controller (NIC) 114 to receive the integrations. For example, the routing unit 112 can configure the NIC to receive the integrations via a particular port. In another example, the integrations may be encrypted by the target system 106 and the NIC 114 may include software for decrypting the integrations. It should be appreciated that although FIG. 1 depicts a connection between the source system 104 and the target system 106 via an NIC 114, the connection can be a direct connection or an indirect connection. An indirection connection can include one or more computing devices in addition to the NIC 114 that are used to exchange communication between the source system 104 and the target system 106. Furthermore, in some embodiments, the source system 104 and the target system 106 may communicate without the use of the NIC 114.

In any event, the source system 104 can transmit a message (e.g., an API call) to the target system 106 to request a copy of the first integration set 110. The target system 108 can copy the first integration set 110 to generate the second integration set 116. The second integration set 116 can be stored in a project database 118. In particular, the second integration set 116 can be stored in a first project 120. The first project 120 can include a container that includes a collection of assets (e.g., integrations, lookups, connections, links, and/or libraries) used for a software solution. A state of the data that is copied from the target system 108 to the source system 104 can be static. For example, there may be no database schema changes, no changes to existing data, and/or no changes to runtime endpoints. Each project stored in the project database 118 can include a unique identifier that can be used to access the project.

The second integration set 116 can be a copy of the first integration set 110. The target system 106 can further copy other assets that are dependent from the first integration set. For example, the target system 106 can copy other assets, such as connections, lookups, links, and/or libraries. The source system 104 can store the connections, lookups, and/or libraries in the first project 120. As the first project 120 is self-contained, the connections may only be used to trigger other assets stored in the first project 120. An asset stored in the first project 120 may only be able to use the lookups also stored in the first project 120. Furthermore, an asset library stored in the first project may only be able to use a callout (e.g., JavaScript callout) to invoke a functionality of another asset stored in the first project 120. In some embodiments, the first project may include links to external content. For example, a link may be a uniform resource locator (URL) to an informational webpage. A user can use a link to access information on one or more assets. Links may be used to access information (e.g., a GitHub page), and may not be available during runtime. Each asset may have a unique asset identifier, and each other asset may use the unique identifier to identify the asset. The source system can move one asset from one project to another project. However, once the asset is moved to the other project, the asset may only be available to other assets in the other project, and the asset may only be able to access other assets in the other project.

Based on storing the second integration set 116 in the project database 118, an identifier unit 122 can generate metadata for each integration in the second integration set 116. For example, the second integration set 116 can include a first integration and a second integration. The identifier unit 122 can include first metadata associated with the first integration and second metadata associated with the second integration to the first project 120.

The identifier unit 122 can set the metadata for each of the first revision identifier and the second revision identifier to an initial value. For example, the identifier unit 122 can respectively set the first revision identifier and the second revision identifier to zero. The initial value can indicate that the first integration and the second integration have not changed since being received from the target system 108.

A user can use the user device 102 to access the second integration set 116. In an example, the user can analyze the second integration set 116 and determine that a first integration may be changed to address the software solution. The user can further determine that the second integration may remain the same. Changing the first revision identifier can include changing one or more portions of the first revision identifier. For example, the first integration can include name=input (“Please provide your name.”). The user can change the first integration to name=input (“What is your name?”). The user can then save the updated first integration in the project database 118 and, in particular, in the first project 120. The identifier unit 122 can be configured to monitor the project database 118 and any integrations that have been saved in the project database 118. Based on detecting that the user saved the first integration, the identifier unit 122 can access the first metadata associated with the first integration. The identifier unit 122 can further increment the first revision identifier to indicate that the saved first integration is a new version of the first integration. As used herein, a new version can be a revised version of an integration. For example, if the metadata indicated that the first revision identifier was a 0, the identifier unit 122 can increment the second revision identifier to a 1. As indicated above, in this example the user may determine that the second integration set 116 does not need to be changed and leave the second integration as is. As the second integration remains the same, the identifier unit 122 does not change the second metadata to indicate a new version of the second integration set 116.

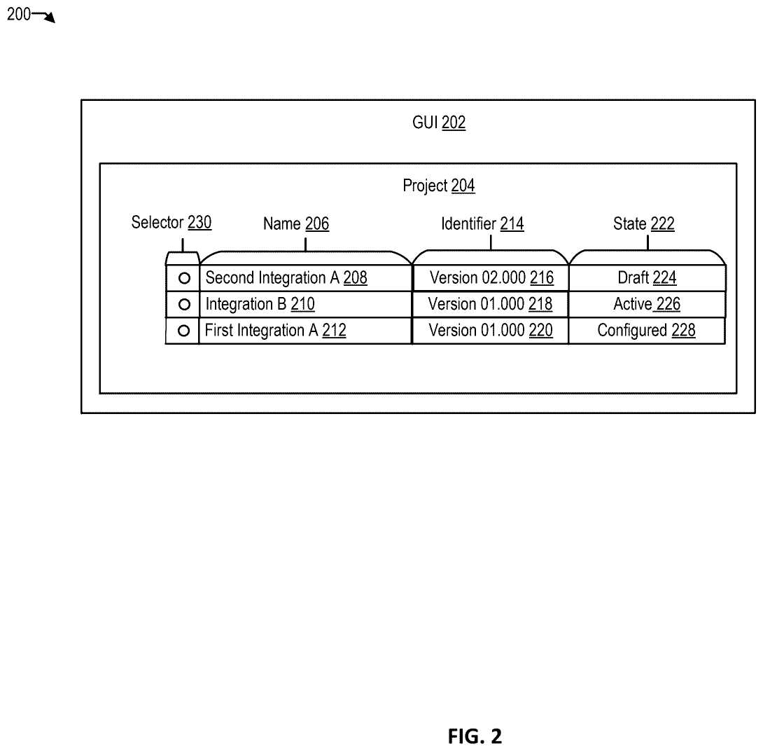

The user can access a graphical user interface (GUI) on the user device 102. The GUI is described with more particularity with respect to FIGS. 2-4. The user can use the GUI to select a project (e.g., first project 120) from a set of projects stored in the project database 118. The GUI can display the name of each integration that is included in the project. For example, continuing with the example above, the GUI can display a name for the first integration (e.g., “(e.g., Shopper_Create_Customer_Inbound)”) and a name of the second integration (e.g., “Shopper_Create_Product_Outbound”). The GUI can also display the revision identifier for each integration. The revision identifier can indicate the version of the integration. As indicated above, the GUI can display a 0 for the first revision identifier and a 1 for the second revision identifier. The user can use the GUI to select one or more integrations. Continuing with the example, the user can select the first integration as the user has changed the first integration from version 0 to version 1. The user can choose to not select the second integration as the second integration was not changed. In a conventional system, the user may not have this option. Rather, the project would be deployed from the source system to the target system to include both the first integration and the second integration.

The source system 104 can further include a packager unit 124 for generating an updated project. The packager unit 124 can receive the user selections via the GUI. The packager unit 124 can further access the first project 120 based on the project selection made by the user. The packager unit 124 can further access the first integration based on the user selection. The packager unit 124 can further include the first integration as a third integration set 126 for a second project 128. It should be appreciated that both the first project 120 and the second project 128 can include more than integrations. For example, each of the first project 120 and the second project 128 can include, for example, lookups, connections, links, and/or libraries. The user can use the GUI to similarly determine which of the lookups, connections, links, and/or libraries from the first project 120 to include in the second project 128.

The packager unit 124 can transmit the second project 128 to the compression unit 126. The compression unit 126 can use a compression algorithm (e.g., LZMA2, multi-layer perceptron (MLP)-based compression algorithm) to compress the second project 128. For example, the second project 128 can be a data file, and the compression unit 126 can use the compression algorithm to encode the second project 128 to reduce the size (e.g., reduce the number of bits) of the data file. The packager unit 124 can notify the routing unit 112 that the second project 128, in compressed format, is ready to be deployed to the target system 106.

The routing unit 112 can transmit the second project 128 to the target system 106 via the NIC 114. The target system 106 can decompress the second project 128 and install the first integration at the target system.

As indicated above, the conventional method can include deploying each integration (e.g., the first integration and the second integration of the first project 120) from a source system to a target system. Therefore, even if only the first integration was changed and the second integration stayed the same, both integrations would be deployed to the target system. Furthermore, as the target system may be unaware as to which integration was changed, it may install both the first integration and the second integration. Therefore, the target system, using the conventional method, may disable a first endpoint while installing the first integration. The target system may also disable a second endpoint while installing the second integration. As the second integration may not have changed at the source system, installing the second integration includes simply replacing an integration with the same integration. Furthermore, even though the second integration did not change the target system, using the conventional method, may still have disabled the endpoint used to call the second integration.

The herein described techniques can permit the source system 104 to decouple the first integration from the second integration. Therefore, the source system 104 can deploy a second project 128 to the target system 106 that only includes the first integration. The target system 106 can then disable a first endpoint while installing the first revision identifier, while keeping a second endpoint associated with the second integration active.

FIG. 2 is an illustration 200 of an example GUI for deploying integrations, according to one or more embodiments. A user can use a GUI 202 to select which integrations to deploy to a target system (e.g., target system 108). As illustrated, the GUI 202 can display a project 204 that include an integration set. As illustrated, the integration set includes three integrations. Each integration can include a name 206 (e.g., integration A 208, integration B 210, and integration A 212). In some embodiments, the GUI 202 can display two versions of the same integrations (e.g., integration A 208 and integration A 212). This can permit a user to simultaneously view each existing version of an integration on the GUI 202. In this way, when a user is determining which integration to deploy to a target system (e.g., target system 106), the user can see each available version of an integration.

Each name 206 can be an identifier assigned to the integration by a user that wrote the integration. The GUI 202 can display a respective identifier 214 for each integration. For example, the GUI 202 can display that the second integration A 208 can be associated with the version 02.000 216. This can indicate that second integration A 208 is the revised version of the first integration A 212. The GUI 202 can display that integration B 210 can be associated with the version 01.000 212. This can indicate that integration B 210 is a first version. The first integration A 208 can be associated with the version 01.000 220. This can indicate that integration A 212 is a first version. Each version can be stored in the project 204 as metadata which is associated with integration. Therefore, if an integration is selected to be deployed to a target system, the metadata can be included in the deployment.

Each time that a new version of an integration is created, an identifier unit (e.g., identifier unit 122) can increment the revision identifier for the integration. The identifier unit can be triggered to increment the revision identifier through various techniques. In some instances, each time that a user saves an integration on a source system (e.g., source system 104), the identifier unit can increment the revision identifier. In other instances, the identifier unit can be configured to increment a revision identifier based on an instruction from a user. For example, at a point in time (e.g., T₀), a user may have created a first version (e.g., version 01.000 220) of an integration (e.g., integration A 212). At a later point in time (e.g., T₁), the user can create a second version (e.g., version 02.000 216) of the same integration (e.g., integration A 208). For example, a user may want to revise a portion of integration while still maintaining the original version of the integration. In another example, the user may create a new version of the integration each time that an update is requested by a customer. In any event, the identifier unit can be triggered to increment the revision identifier for the integration. As illustrated in FIG. 2, the identifier unit has incremented the revision identifier from version 01.000 220 to version 02.000 216.

The GUI 202 can also display a state 222 for each integration. For example, the GUI 202 can display that the state 222 of second integration A 208 is draft 224. Draft 224 can indicate that the second integration A 208 is not in executable form. For example, a user, such as a developer, may still be refining the second integration A 208. Also as illustrated, the GUI 202 can display that the state 222 of integration B 210 is active 226. Active 226 can indicate the integration B 210 has been activated. An activation integration available for use by another entity. For example, an application can use an endpoint to call integration B 210, and integration B 210 can execute a function in response to the call. As the integration is available for use, a project that includes an active integration may not be deleted without moving the active integration to another project. Furthermore, only one version of an integration can be active at any given time. For example, the second integration A 208 were to be active, then the first integration A 212 may not be active, and vice versa. In some instances, a source system can activate an entire project rather than individual integrations. This may result in the bulk processing of all integrations in an integration set. For example, prior to deployment, the source system may activate each integration in the set of integrations to be deployed.

Also as illustrated, the GUI 202 can display that the state 222 of first integration A 212 is configured 226. Configured 228 can indicate that the first integration A 212 is executable, but for whatever reason is not accessible by another entity. A user can user the GUI 202 to change the state 222 of an integration. For example, upon completed the second integration A 208, a user could change the state from draft 224 to active or configured. Similarly, a user can use the GUI 202 to change the state of integration B 210 and first integration A 212.

The GUI 202 can also include a respective selector 230 for each integration. Each selector can be an element that a user can interact with in order to select an integration for deployment to a target system. For example, the user can user a peripheral device, such as a mouse or keyboard to hover over the element and click on the element to select an integration. A packager unit (e.g., packager unit 124) can access each selected integration from a first project (e.g., first project 120) and store each selected integration in a second project (e.g., second project 128). A compression unit (e.g., compression unit 126) can compress the second project. A routing unit (e.g., routing unit 112) can cause the compressed second project to be deployed to the target system.

It should be appreciated that FIG. 2 illustrates an embodiment of the GUI 202 and a person having ordinary skill in the art can contemplate various modifications of the GUI 202 while still maintaining the ability to perform the functions described herein.

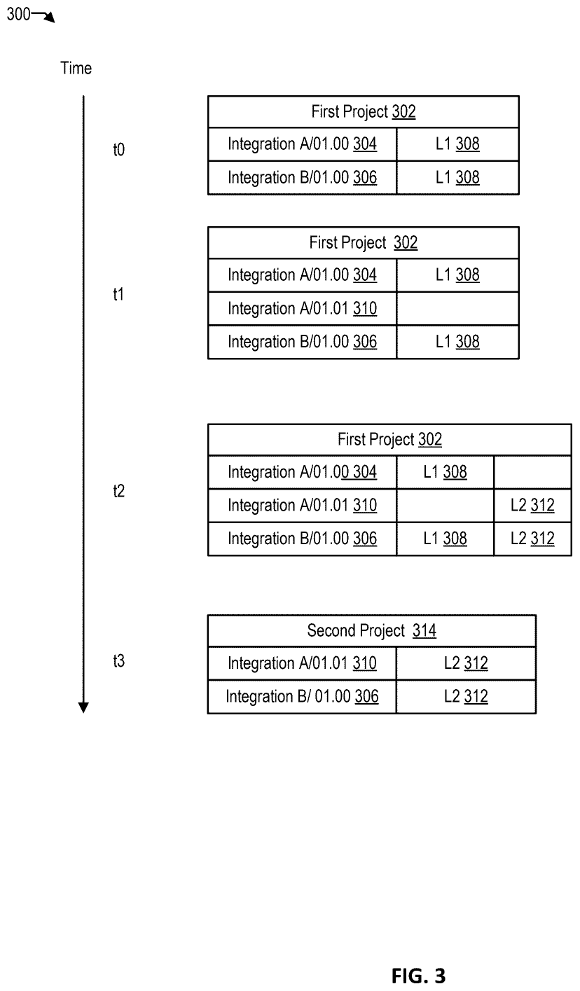

FIG. 3 is an illustration 300 of an example GUI timeline, according to one or more embodiments. A GUI can change based on the integrations included in a project. As indicated above, various modification of the GUI elements can be contemplated FIG. 3 provides an example of the GUI changes based on integration changes. The GUI elements in FIG. 3 can be different than the GUI elements in FIG. 2. At to, a first project 302 (e.g., first project 120) can include a first integration with the name integration A/01.00 304 and a second integration with the name integration B/01.00 306. As illustrated in FIG. 2, the integration version can be displayed on the GUI distinctly from the integration name. As illustrated in FIG. 3, an integration can be displayed on the GUI to include an integration identifier (e.g., Integration) and a version (e.g., 01.00). Integration A/01.00 304 can be associated with a label L1 308, where the label can be a unit of deployment. Integration B/01.00 304 can also be associated with a label L1 308. The label L1 308 can be used as an indicator as to which integrations to deploy to a target system (e.g., target system 106). Therefore, rather than selecting individual integrations via a selector, a source system can determine which integrations to deploy based on the labels. For example, each integration associated with a particular labels can be scheduled for deployment.

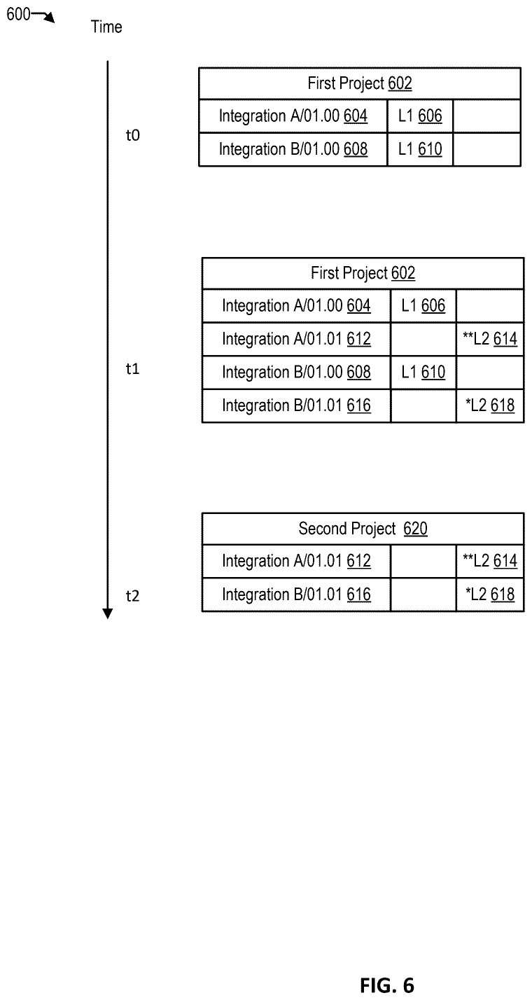

At t₁, a user may create a new integration with the name integration A/01.01 310 and the GUI can display the new integration. It can be seen in FIG. 3 that, based on the name, the integration A/01.01 310 may be a new version of integration A/01.00 304. For example, based on the name, it can be seen that the version of integration A/01.00 304 may be 01.00 and the version of integration A/01.01 310 is 01.10. The version can be indicated by the magnitude of the version number, and in this case 01.10 is 00.10 greater than 01.00. It can further be seen that the GUI can continue to display integration A/01.00 304 and integration B/01.00 304. As described further with respect to FIG. 6, the GUI can also provide an indication of whether a revision to an integration is a major revision or a minor revision. If a revision is a major revision, the target system may need to disable an endpoint while installing the revised integration. If, however, a revision is a minor revision, then the target system may allow an endpoint to remain enabled while installing the revised integration. It should be appreciated that the state of the first project 302 at t₁ is provided for illustration. As the source system has not updated the label L1 308 to reflect the new integration, the GUI may not display the state of the project at t₁.

At t₂, the GUI can display the first project 302 with updated labels. For example, an identifier unit (e.g., identifier unit 122) can be triggered to update the labels for the first project 302. For example, each time that a user saves an integration, the identifier unit can generate a new label. In other instances, the identifier unit can be configured to generate a new label based on an instruction from a user. The identifier unit can determine each integration that is associated with a highest label value. As illustrated, the highest label value is 1 (e.g., L1 308). The identifier unit can then determine whether an updated version of an integration has been generated for an integration associated with the highest label value. For example, the identifier unit can analyze the name and version numbers of each integration. The identifier unit can determine whether two integrations have the same name, but one integration has a higher version number than the other integration. As illustrated, integration A/01.00 304 is associated with label L1 308 and integration A/01.10 310 is an updated version. The identifier unit can further determine that integration B/01.00 306 is associated with the label L1 308. In some instances, integration A/01.00 304 may not be compatible with integration A/01.10 310, and the labels can be indicative of the incompatibility. Therefore, the integrations that are transmitted to a target computing system may be required to be the same label to avoid incompatible integrations from being received at the target computing system.

The identifier unit can determine that integration A/01.10 310 and integration B/01.00 306 are to receive updated labels. The identifier can create the label L2 312 integration A/01.10 310 and the label L2 312 for integration B/01.00 306. The GUI can display the first project 302 with the updated labels for integration A/01.10 310 and integration B/01.00 306. The labels can provide a user with a visual indication of the label values. The labels can also anchor one integration to another integration. For example, rather than select individual integrations for deployment as described with respect to FIG. 2, a user can select a label as an identifier for deployment. The user can select L2 312 and a packager unit (e.g., packager unit 124) can access each integration (e.g., A/01.10 310 and integration B/01.00 306) associated with L2 312. It should be appreciated that the user could have selected L1 308 if desired, and the packager unit may have accessed the integrations associated with L1 308. It should be appreciated that either the identifier (e.g., 01.01) or the label L2 can act as a revision identifier. One having ordinary skill in the art can contemplate that different GUIs can be configured differently and various GUI elements can be used to indicate that a revision has occurred.

At t₃, the packager unit can generate a second project 314 (e.g., second project 128). In some embodiments, the second project 314 can include the revised integrations that are to be deployed to the target system (e.g., target system 106). The second project 314 can include the integrations (e.g., A/01.10 310 and integration B/01.00 306) associated with L2 312 in a third integration set (e.g., third integration set 126). The packager unit can further include any dependent assets (e.g., lookups, connections, links, and/or libraries) in the second project 314. A compression unit (e.g., compression unit 126) can use a compression algorithm to compress the second project 314. A routing unit (e.g., routing unit 112) configure and transmit the second project 314 to a target system (e.g., target system 106). In some instances, the routing unit can configure a NIC (e.g., NIC 114) to transmit the second project 128 to the target system. At the target system, the endpoints associated with integrations (e.g., integration A/01.10 310 and integration B/01.00 306) can be disabled and the integrations can be installed.

In some instances, the second project, can further include instructions for updated the endpoints associated with the integrations. Consider an example, in which the endpoint is as follows:
/ic/api/integration/flows/rest/project/integration_A/01.00/demo,
   for integration A/01.00 304. The endpoint can indicate that the version number is 01.00. The second project can include instructions to change the endpoint to
/ic/api/integration/flows/rest/project/integration_A/01.01/demo,
   after installing integration A/01.01 310. In particular, the instruction can include changed 01.00 to 01.00 to reflect that the endpoint can be used to call integration A/01.10 310.

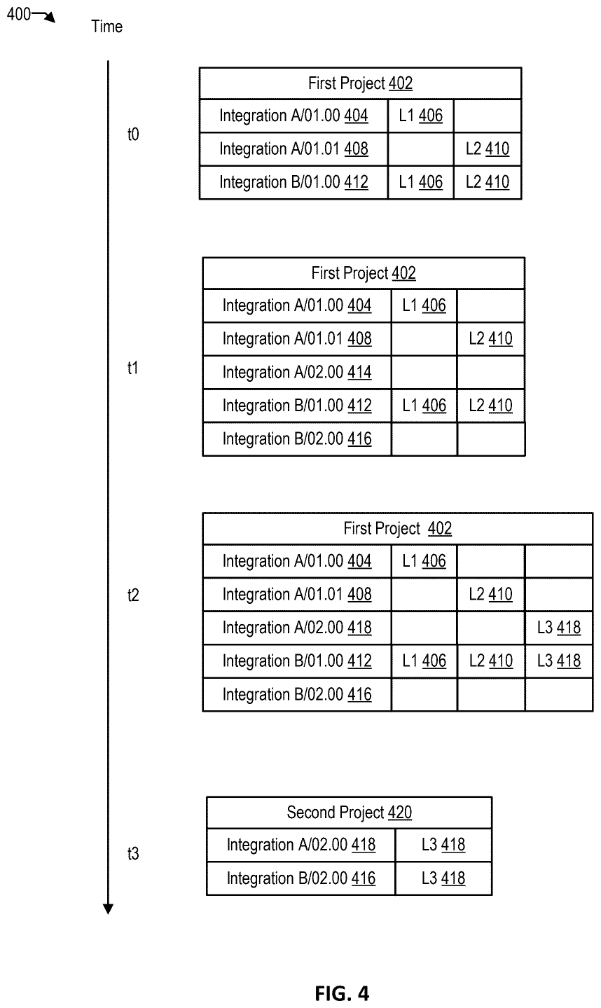

FIG. 4 is an illustration 400 of an example GUI timeline, according to one or more embodiments. A GUI can change based on the integrations included in a project. As indicated above, various modification of the GUI elements can be contemplated FIG. 4 provides an example of the GUI changes based on integration revisions and integration states. The GUI elements in FIG. 4 can be different than the GUI elements in FIG. 2.

At to, a GUI can display a first project 402 (e.g., first project 120). As illustrated, the first project 402 includes integration A/01.00 404 associated with label L1 406. The first project 402 can include integration A/01.01 408 associated with label L2 410. The label (e.g., L2 410) can be a revision identifier that indicates that integration A/01.01 is a revived version of integration A/01.00. The first project 402 can also include integration B/01.00 412 associated with L1 406 and L2 410.

At t₁, a user may generate integration A/02.00 414, a new version of integration A. The user may further generate integration B/02.00 416, a new version of integration B. The user may further indicate a state of each of integration A/02.00 414 and integration B/02.00 416. The user may indicate that integration A/02.00 414 is executable and in either a configured state or an active state. The user may indicate that integration B/02.00 416 is not executable and in a draft state. The indicated of the state may or may not be displayable on the GUI. The states can be stored as metadata in the first project. In either case, as the labels of the integrations have not been updated, the GUI at t₁ may not be displayed for a user.

At t₂, the GUI can display the first project 402 with updated labels. An identifier unit (e.g., identifier unit 122) can be triggered to update the labels for the first project 402. In this scenario, the identifier unit can access the states and determine which integrations are indicated as executable and which integrations are indicated as not executable. The identifier unit can further process the integrations that are indicated as executable and elect to not process any integrations that are not indicated as executable.

For each integration that is indicated as executable, the identifier unit can determine each integration that is associated with a highest label value. As illustrated, the highest label value 2 (e.g., L2 410). The identifier unit can then determine whether an updated version of an integration has been generated for an integration associated with the highest label value. As illustrated, integration A/01.01 408 is associated with label L2 410 and integration A/02.00 418 is an updated version. The identifier unit can further determine that integration B/01.00 412 is associated with the L2 410. However, as indicated above, integration B/02.00 416 is indicated to not be in an executable state. Therefore, the identifier unit can elect to not process integration B/02.00 416.

The identifier unit can determine that integration A/02.00 418 and integration B/01.00 412 are to receive updated labels. The identifier unit can increment the label value to indicate a higher label value. As illustrated, the identifier unit can create a label L3 418 for integration A/02.00 418 and a label L3 418 for integration B/01.00 412. The GUI can display the first project 302 with the updated labels for integration A/02.00 418 and B/01.00 412. The user can select L3 418 and a packager unit (e.g., packager unit 124) can access each integration (e.g., A/02.00 418 and integration B/01.00 412) associated with L3 418.

At t₃, a packager unit (e.g., packager unit 124) can generate a second project 420 (e.g., second project 128). In some embodiments, the second project 420 can include the revised integrations that are to be deployed to the target system (e.g., target system 106). The second project 420 can include the integrations (e.g., integration A/02.00 418 and integration B/01.00 412) associated with L3 418 in a third integration set (e.g., third integration set 126). The packager unit can further include any dependent assets (e.g., lookups, connections, links, and/or libraries) in the second project 420. In some instances, the second project, can further include instructions for updating the endpoints associated with the integrations. A compression unit (e.g., compression unit 126) can use a compression algorithm to compress the second project 420. A routing unit (e.g., routing unit 112) configure and transmit the second project 420 to a target system (e.g., target system 106). In some instances, the routing unit can configure a NIC (e.g., NIC 114) to transmit the second project 420 to the target system. At the target system, the endpoints associated with integrations (e.g., integration A/02.00 418 and integration B/01.00 412)) can be disabled and the integrations can be installed.

It should be appreciated that multiple deployments can be created from a single project (e.g., the first project 120). Each deployment can provide a mechanism for delivering a subset of artifacts (e.g., integrations) to a target system (e.g., target system 106). The below illustration can describe the concept of multiple deployments from a single project over a timeline (t0-t5). The following abbreviations are used: source system (SS) (e.g., source system 104), external artifact (EA), and target system (TS) (e.g., target system 106). For the below illustration, it should be appreciated that a project associated with the source system (SS) can be a first project (e.g., first project 120). It should further be appreciated that a project associated with the external artifact (EA) can be a second project (e.g., e.g., second project 128). The project associated with the external artifact can be include revised integrations selected from the project associated with the source system.

T0 (initial development in an SS)

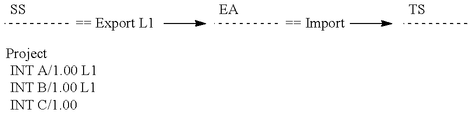

t1 (export L1 from SS)

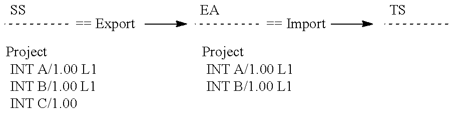

t2 (import L1 to TS)

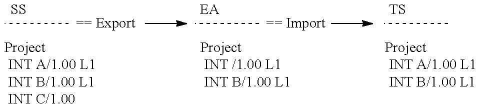

t3 (new development in SS)

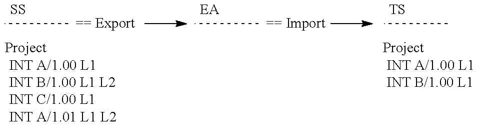

t4 (export L2 from SS)

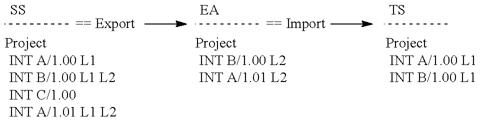

t5 (import L2 to target system)

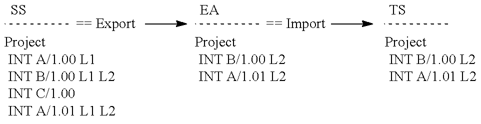

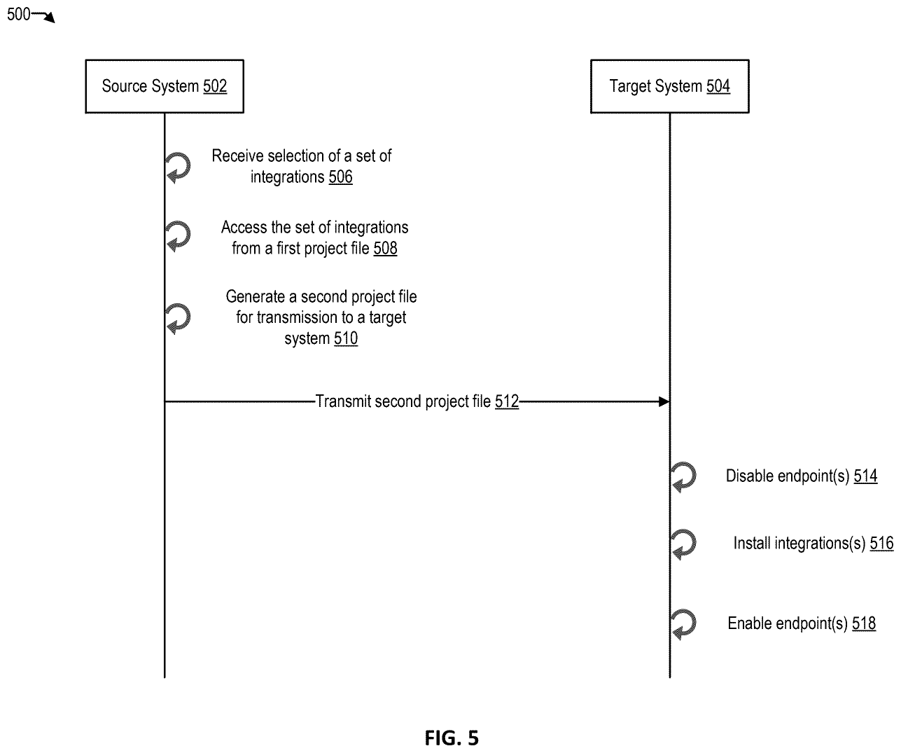

FIG. 5 is a signaling diagram for project deployment, according to one or more embodiments. As illustrated, a source system 502 can be in communication with a target system 504. While the operations of process 500 is described as being performed by generic computers, it should be understood that any suitable device may be used to perform one or more operations of this method. Process 500 (described below) is illustrated as signaling diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The techniques described herein can be used for various use cases, and FIG. 5 describes a process for implementing the herein described techniques for the use cases. A first use case can be that a CSP (e.g., a source system) can deliver a project to a store (e.g., a target system). A second use case can be that customer (e.g., a source system) transmits a problematic project to the CSP (e.g., a target system). A third use case can be a CSP customer wants to transfer a project from one service instance (e.g., a source system) to another service instance (e.g., a target system) At 506, the source system 502 (e.g., source system 104) can receive a selection of a set of integrations. The source system 502 can be a computing system managed by a CSP and accessible to a user, such a software developer employed by the CSP. A CSP customer can request that the CSP generate a software solution for an issue at the target system 504. The user can develop the software solution that includes a set of integrations. The user can select which integrations are to be deployed to the target system. For example, the user can use a user device (e.g., user device 102) to access a GUI and enter selection to identify the set of integrations. The user can use various methods to select the integrations in the set of integrations. In some embodiments, the user can individually select each integration using GUI selector element as indicated above. In other embodiments, the user can select the integrations based on a label as indicated above. In some embodiments the user can further provide a project identifier to identify a first project (e.g., first project 120) within which the selected set of integrations are stored.

At 508, the source system 502 can access the set of integrations from a first project. For example, the source system can access a project database (e.g., project database 118) and use the project identifier to retrieve the selected set of integrations from the first project. In addition to retrieving the selected set of integrations, the source system 502 can retrieve any dependent assets from the project. The dependent assets can include, for example, lookups, connections, links, and/or libraries.

At 510, the source system 502 can generate a project (e.g., second project 128) for deployment. The second project can be implemented as a container and include the selected set of integrations (e.g., third integration set 126). The second project can further include any dependent assets, such as the lookups, connections, links, and/or libraries. In some embodiments, the second project can further include instructions for amending endpoints that are associated with the selected set of integrations. For example, the instructions can indicate that the endpoints are to be amended to reflect a current version of the integrations.

In some instances, a user can use a user interface (UI) to generate a backup copy of a project. The backup copy can indicate the project name, revision identifier, and associated assets. The source system 502 can convert the backup copy into the second project to be transmitted to the target system 504. The project can include a container and the source system 502 can store the associated assets in the container.

At 512, the source system 502 can deploy the second project to the target system 504. The source system 502 and the target system 504 can be connection via a network (e.g., a LAN or WAN). The source system 502 can further deploy the second project to the target system via the network. The second project can be externalized (e.g., moved from the source system 502 to the target system 504) as a self-contained file that contains each asset and metadata that describes each asset. The metadata can include project information, such as a tenant identifier, service instance identifier, a project identifier, asset identifier(s), and revision identifier. The metadata can be immutable, and used to detect copying of the project. For example, if the project is copied at the target system, the project identifier, and the revision identifier can remain the same, such that a comparison of the project identifier and revision identifier of two projects can help determine whether one project is a copy of another project.

A user can use a user interface (UI) to control the export of the project from the source system 502 to the target system 505). The project can include various types of assets, such as connection assets (e.g., network configurations, API endpoints, and communication protocols) for a specific execution environment. The user can use the UI to select one or more connection assets to be included in the project. The project can also include assets with sensitive information (e.g., proprietary information). The user can use the UI to remove sensitive information from the assets.

The target system 504 can include various endpoints where each endpoint is associated with an integration name and a major version of the integration. For example, consider a set of integrations (integration A 1.0.x, integration A 1.1.x, integration A 1.2.x, and integration A 2.0.x). For this set of integrations, only two endpoints may be active at the target system 504. For example, the endpoints at the target system can be A-1 and A-2, where A-1 is associated with integration A 1.0.x, integration A 1.1.x, and integration A 1.2.x. Additionally, A-2 can be associated with integration A 2.0.x. With respect to integration A 1.0.x, integration A 1.1.x, integration A 1.2.x, only one of these integrations can be active at a given point in time. For example, if integration A 1.0.x is active, then endpoint A-1 can invoke integration A 1.0.x. If, at some point, integration A 1.2.x is to be made active, then integration A 1.0.x can be deactivated. Once integration A 1.0.x is deactivated, then integration A 1.2.x can be activated.

At 514, the target system 504 can deactivate endpoints associated with the set of integrations in the second project. The endpoints can be used to call the integrations. Therefore, as the integrations that are currently being used are replaced by the integrations in the second project, the endpoints can be disabled to prevent the endpoint from calling the integration that is being replaced. It should be appreciated that the target system may include additional integrations. However, as only the set of integrations are being used to replace certain integrations, endpoints that are associated with integrations that are not being replaced, do not need to be disabled.

At 516, the target system 504 can install the set of integrations from the second project. A user at the target system 504 can either import the project file or install a project at the target system 504 as long as a copy of the project has not previously been imported or installed into the target system 504.

FIG. 6 is an illustration of an example GUI timeline 600, according to one or more embodiments.

A revision to an integration can either be a major revision or a minor revision. A major revision to an integration can be a revision that requires the target computing system to disable an endpoint to install the revised integration. For example, as the revised integration is being installed at the target system, the endpoint may be disabled to prevent unauthorized access to the revised integration. In another example, the endpoint may be disabled as part of a load balancing strategy to divert traffic to another endpoint. There may also be other appropriate reasons why an endpoint may be disabled at the target system. A minor revision to an integration can be a revision to an integration that permits the target computing system to install the revised integration without disabling an endpoint to install the revision integration. For example, a target system may include multiple instances of an integration that can be accessed via a single endpoint. The target system may perform a rolling update, in which the integration instances are updated individually. Furthermore, the integrations that are waiting to be updated may still be functional for their intended purpose. Therefore, the endpoint can still be used to call integration instances that are not being updated.

In the event that there is a major revision, an endpoint at the target computing system may need to be disabled as the integration is being installed. In the event of a minor revision, the endpoint may not need to be disabled. Furthermore, for a major revision, the endpoint may also need to be changed. For example, the endpoint can be changed to indicate the revised version of the integration. For a minor revision, the endpoint at the target system may remain unchanged even after installing the minor revision of the integration. The target system can receive a major revision of an integration and a minor revision of the integration. The major revision of the integration may be associated with a first set of assets and the minor revision of the integration may be associated with a second set of assets. In some instances, both the major revision of the integration and the minor version of the integration can be associated with the same endpoint. The target computing system can determine to install both the major revision and the minor revision of the integration. For example, the target computing system can determine to install the major revision of the integration. During the installation process, the target computing system can disable an endpoint and install the major revision of the integration. The target computing system can further generate a new endpoint that indicates the major revision of the integration. The target computing system can then determine to install the minor revision of the integration. The target computing system can allow the new endpoint to remain enabled during the installation process. The target computing system can further continue using the new endpoint after the installation of the minor revision of the integration.

At T₀, A GUI can display several projects (e.g., a first project 602 and a second project 620). In some examples, the first project 602 includes integration A/01.00 604 and integration B/01.00 608. Each of the integrations can be unrevised integrations and respectively be associated with labels L1 606 and L2 608. At T₁, a developer can make a major revision to integration A/01.00 604 to generate integration A/01.01 612. An identifier unit (e.g., identifier unit 122) can increment the identifier from 01.00 to 01.01. The revision can be a major revision, such that the target computing system may need to disable an endpoint in order to install the revision integration. As the revision is a major revision in this example, the identifier unit can not only increment the label from L1 606 to an L2, but also indicate that the revision is a major revision. An integration revision can be a major revision if the revised integration is functionally different from the original integration. For example, each integration can be associated with a set of assets (e.g., lookups, connections, links, and/or libraries). For a major revision, one or more of the assets may have been modified such that an asset associated with the original integration (e.g., integration A/01.00 604) has been revised or deleted. Alternatively, in some examples, an asset that was not previously associated with the original integration (e.g., integration A/01.00 604) is now associated with the revised integration (e.g., integration A/01.1 612). For example, a developer may build a library and associate the library with a revised integration.

The developer may also revise integration B/01.00 608 to generate the revised integration B/01.01 616. In this example, the revision may be a minor revision, such that the target computing system may not need to disable an endpoint to install the integration B/01.01 616. The revision may be a minor revision if the revised integration is functionally equivalent to the original. For example, this may be the case if the assets associated with the original integration (e.g., integration B/01.00 608) remain the same for the revised integration (e.g., integration B/01.01 616). The identifier unit can increment the label from L1 610 to L2, and in addition indicate that the revision is a minor revision. It should be understood, however, that GUIs can have different visual elements and a different GUI may indicate that a revision is major or minor by using different graphical elements than those illustrated in FIG. 6.

At T₂, a developer can select a set of revised integrations to be packaged and transmitted to a target computing system. For example, the developer can select all revised integrations to be packaged and transmitted to the target computing system. In instances where the GUI displays both major and minor revisions, a packager unit (e.g., packager unit 124) can create a second project 620 and include each revised integration in the second project 620 regardless of whether the revision is a major revision or a minor revision. The second project 620 can be transmitted to the target computing system. The second project 620 can include the revised versions of the integrations included in the first project 602, but without the unrevised versions of the same integrations. As illustrated, the second project 620 includes revised versions of the integrations (e.g., integration A/01.01 612 and integration B/01.01 616), but not the unrevised versions of the same integrations (e.g., integration A/01.00 606 and integration B/01.00 608). At the target computing system, an endpoint associated with integration A/01.01 612 may be disabled prior to installing the integration. On the other hand, an endpoint associated with integration B/01.1 616 may remain enabled throughout the installation process.

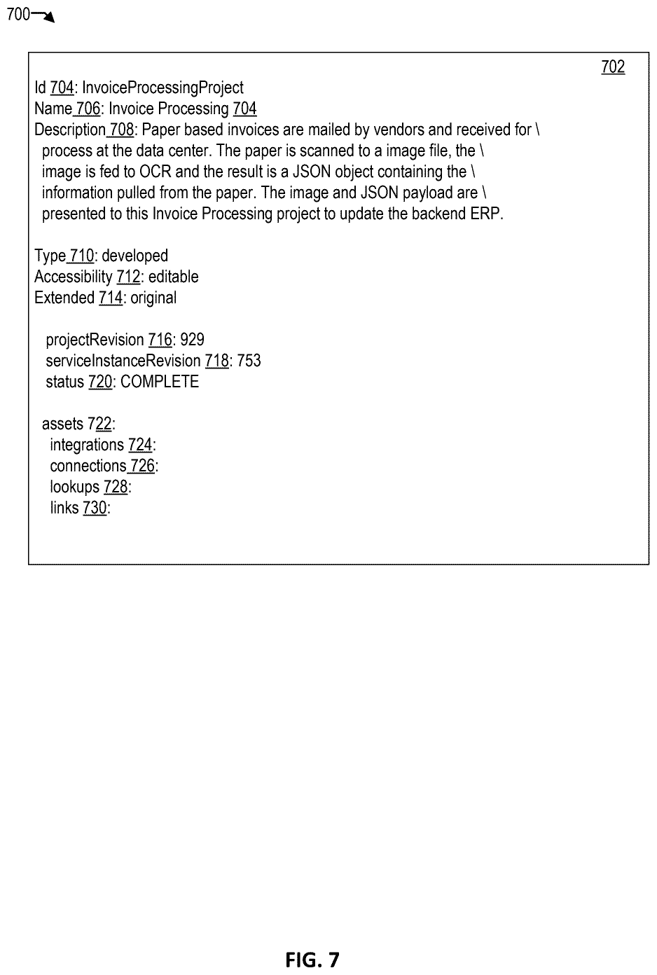

FIG. 7 is an illustration 700 of an example project, according to one or more embodiments. As indicated above, a project 702 can include a software solution organized as a software package, such as a container, that include various attributes, such as type, origin, accessibility, a revision identifier, keyword, documentation link, and a collection of assets. The project 702 can be generated in response to a request from a customer and upon generation, deployed to the customer. As illustrated, the project 702 includes various metadata such as a project identifier 704 (e.g., “InvoiceProcessingProject”), a project name 706 (e.g., “Invoice Processing”), and a project description 708. The project 702 can further indicating the project type 710 (e.g., “developed”). As indicated above, the project type 710 can include, for example, develop, recipe, or accelerator. The project 702 can include an indication of accessibility 712 (e.g., editable”.) As indicated above the accessibility 712 can include black box, viewable, or editable. A block box accessibility can mask each asset from a consumer, with the exception of connections. The user can use the connections to connect with various other assets, but the user is unable to view or edit any other asset. If the accessibility is set to viewable, the consumer can view the assets, but not have the ability to edit the assets. If the accessibility is set to editable, the consumer can edit the assets. The project 702 can include an indication of whether the project 702 is an extended 714. As illustrated, the project 702 is an original. If the project 702 were an extension of another project, then the indication could include “extension.”

The project 702 can include a revision identifier 716. For example, as illustrated, the project 702 includes the revision identifier “929” indicating that this is the 929^{th} revision of the project 702. The project 702 can further include an indication of a service instance revision identifier 718. The project 702 can include an indication of a status 720. As illustrated, the status 702 is “complete.” This can indicate that the project 702 is ready to be deployed to a target system. In other instances, the status 702 can include, for example, “Not complete” to indicate that the project 702 is not ready to be deployed to the target system.

The project 702 can also include assets 722, for example, integrations 724, connections 726, lookups 728, and links 730. Each integration can include software code that contributes to the software solution. Each integration that is included in the project 702 can be selected, for example, as indicated with respect to FIGS. 2-4. Each connection can include, for example, a pathway from one computing system to another computing system, an application programming interface (API), associations between various assets 722, or other appropriate connections. The links 730 can be used to access external resources. For example, a link can include a URL for software training material. Although not illustrated, the project 702 can include other assets 722, such as lookups, connections, links, and/or libraries, or other appropriate assets.

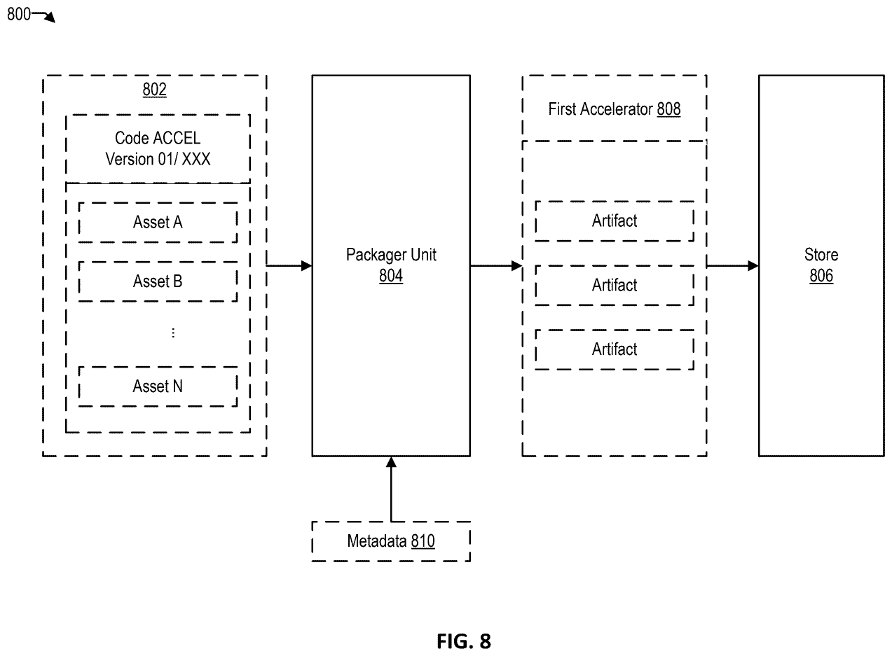

FIG. 8 is an illustration 800 for a process for storing an accelerator in a store, according to one or more embodiments. An accelerator can be a type of project that is to be stored in a store and available for consumption, rather than deployed to a particular target system. For example, in some instances, a customer can communicate with a CSP to address various computing issues at the customer's system. The CSP can generate a software solution, package that solution as a project, and deploy the solution to the customer. In other instances, the CSP can internally generate a software solution, without a customer request, and package the solution as an accelerator type project and store the accelerator in a store. At some point in the future, an entity can access the accelerator from the store and install the accelerator type project at its system. The contents of the accelerator can be similar to contents of the project 702 described with respect to FIG. 7.

The accelerator can be configured to have a static collection of assets. In other words, a consumer that accesses a store and clones the accelerator cannot add or delete assets from the accelerator. A project can further be configured to allow particular actions by a consumer. The various actions can include, for example viewing accelerator content, cloning the accelerator, exporting the accelerator, importing the accelerator, configuring the accelerator, and activating the accelerator. Some of these actions may only be available to a consumer based on the project type (e.g., accelerator, recipe, and developed) and the accessibility (e.g., black box, viewable, and editable. For example, an accelerator type project with blackbox accessibility cannot view the project contents. However, an accelerator type project with viewed or editable accessibility Some other actions can be performed by the consumer regardless of the project type and accessibility. For example, regardless of project type and accessibility a consumer can import a project, configure a project, and activate a project.

A user can provide an input 802 to a packager unit 804. The input 802 can include for example, metadata describing a project, assets (e.g., integrations, connections, lookups, links, and/or libraries). The packager unit 804 can include hardware and software for formatting the input into a form that can be installed by an end user. As illustrated herein, with respect to the accelerator, the end user is a store 806. However, if the project type were recipe or developed, the end user can be a target system, such as target system 106. The packager unit 804 can generate control instructions for specifying a base container image, application code, dependencies, and configuration. The packager unit 804 can build the base container image. The packager unit 804 can access the metadata to determine project name, revision identifier, or other appropriate identifying information. The packager unit 804 can name the base container image using this information. The packager unit 804 can further use this image building process to add one or more artifacts to the container. For example, one artifact can include the metadata, another artifact can include the assets, and yet another artifact can include a working directory for executing the base container image.

The packager unit 804 can output the accelerator 808, where the accelerator 808 is a project to be deployed to the store 806 as a container. The accelerator 806 can be received by the store and made available for installation by a consumer. In some instances, a user can specify metadata 810 to be included in the accelerator 808. In these instances, the metadata can be added to the accelerator 808 from a source external from the input. For example, the packager unit 804 can receive instructions to access an external source (e.g., database) to retrieve the metadata 810.

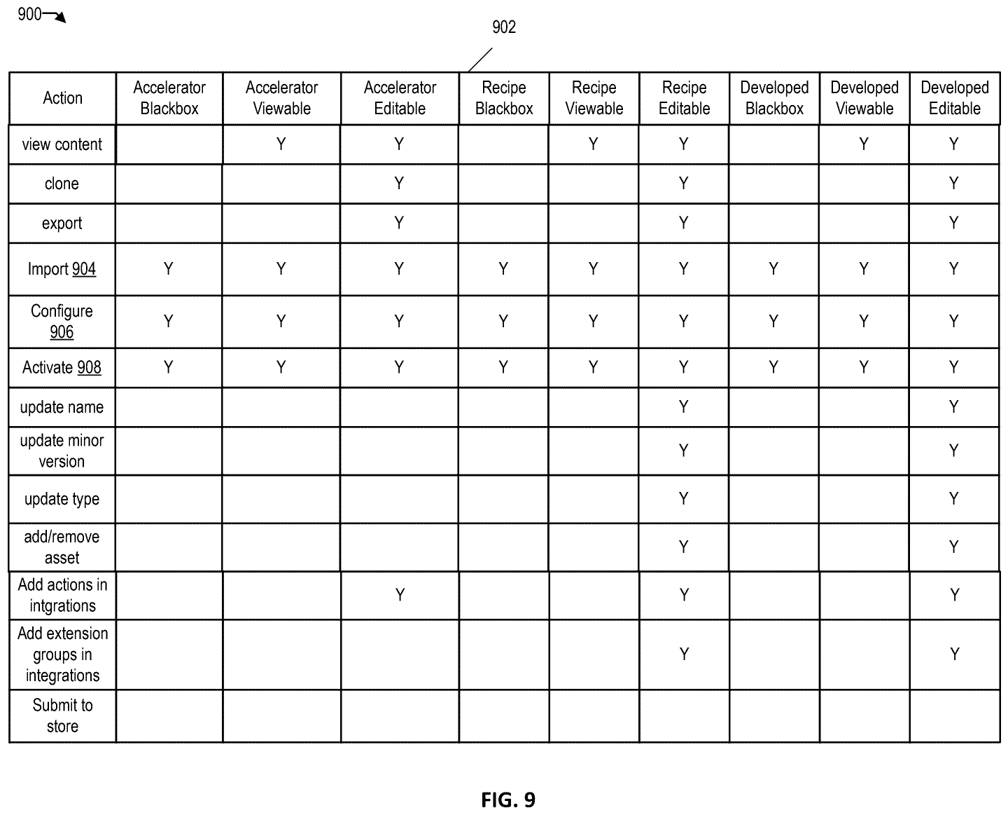

FIG. 9 is an illustration 900 of an example table for managing project type and accessibility with respect to behavior, according to one or more embodiments. As illustrated, each column of the table 902 is associated with a different project type and accessibility combination. For example, the table 902 includes an accelerator blackbox column, an accelerator viewable column, and an accelerator editable column. The table 902 includes similar columns for the recipe and development type projects. Each row of the table 902 is associated with an action that may be performable by an end user. As illustrated the import action 904, the configure action 906, and the activate action 908 can each be performed by an end user regardless of the project type and accessibility. The ability of an end user to perform other actions can be based on the project type and accessibility. For example, an end user can view the project, if the accessibility is editable regardless of the project type.

A user at the source system can configure the type and accessibility of the project via a GUI. For example, the user can use a GUI element to select a project type and an accessibility. The project type and accessibility can be received by a packager unit. Based on the project type and the accessibility, the packager unit can format the assets of the project to conform to the selected project type and accessibility. For example, if the accessibility selection is blackbox, the packager unit can mask the project data to prevent an end user from viewing the data. For example, the packager unit can rearrange the data to make it difficult to discern. The packager unit can encrypt the data using an encryption algorithm. Additionally, if the accessibility selection is viewable, the packager unit can set a permission associated with the data to be read-only.

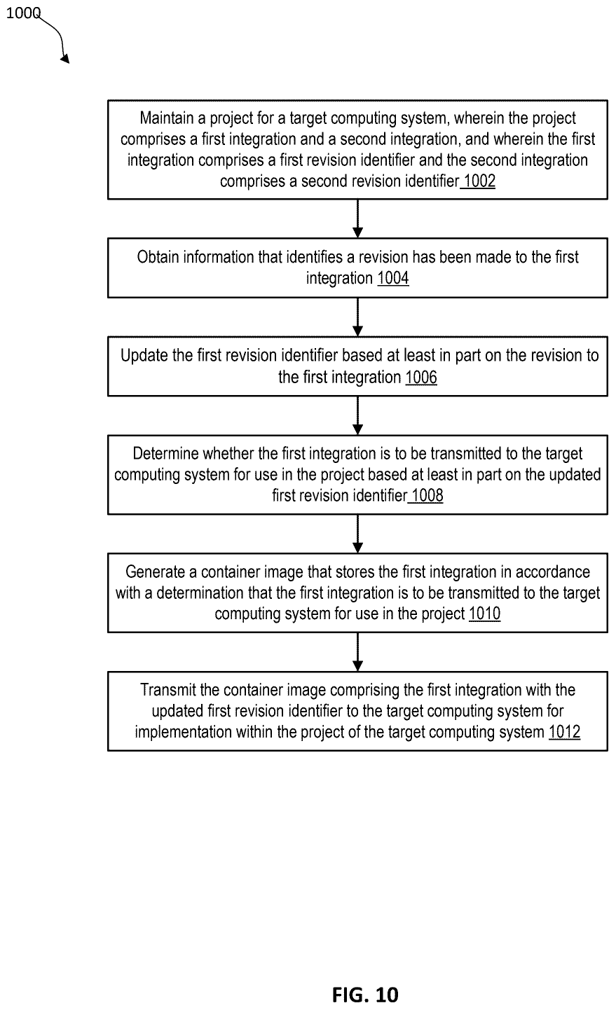

FIG. 10 is a process flow for generating a project file according to one or embodiments. While the operations of process 1000 are described as being performed by generic computers, it should be understood that any suitable device may be used to perform one or more operations of this method. Process 1000 (described below) is illustrated as signaling diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

At 1002, a computing system can maintain a project for a target computing system. The project can include a first integration and a second integration. The first integration can be associated with a first revision identifier. The second integration can be associated with a second revision identifier. For example, a project can be created in relation to a software solution that is to be developed at the computing system. Each integration can be associated with a set of assets, such as lookups, connections, links, and/or libraries.

At 1004, the computing system can obtain information that identifies a revision has been made to the first integration. For example, the computing system can detect that a revised first integration has been saved at the computing system.

At 1006, the computing system can update the first revision identifier based at least in part on the revision to the first integration. The revision identifier can indicate the number of revisions to an integration. The revision identifier can also indicate whether an integration is compatible with another integration.

At 1008, the computing system can determine whether the first integration is to be transmitted to the target computing system for use in the project based at least in part on the updated first revision identifier. The revision identifiers can assist a computing system to separate integrations that are to be transmitted to the target computing system from integrations that are to remain at the computing system. Once the software solution is ready to be deployed, the developer can use a GUI to select a revision identifier for an integration to be transmitted to the target computing system. The computing system can then compare the selected revision identifier with the revision identifiers for each integration in the project. Based on the revision identifiers, the computing system can determine which integrations are to be transmitted to the target computing system.

At 1010, the computing system can generate a container image that stores the first integration in accordance with a determination that the first integration is to be transmitted to the target computing system for use in the project. The container image can store the first integration along with one or more lookups, connections, links, and/or libraries. In some instances, the computing system can use a compression algorithm to compress the container image.

At 1012, the computing system can transmit the container image comprising the first integration with the updated first revision identifier to the target computing system for implementation within the project of the target computing system. The first integration can then be installed at the target computing system

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

[In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 11 is a block diagram 1100 illustrating an example pattern of an IaaS architecture, according to at least one embodiment. Service operators 1102 can be communicatively coupled to a secure host tenancy 1104 that can include a virtual cloud network (VCN) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (LPG) 1110 that can be communicatively coupled to a secure shell (SSH) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (DMZ) tier 1120 that acts as a perimeter network (e.g., portions of a corporate network between the corporate intranet and external networks). The DMZ-based servers may have restricted responsibilities and help keep breaches contained. Additionally, the DMZ tier 1120 can include one or more load balancer (LB) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (API) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (CRUD) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Metadata that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of threat prevention, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

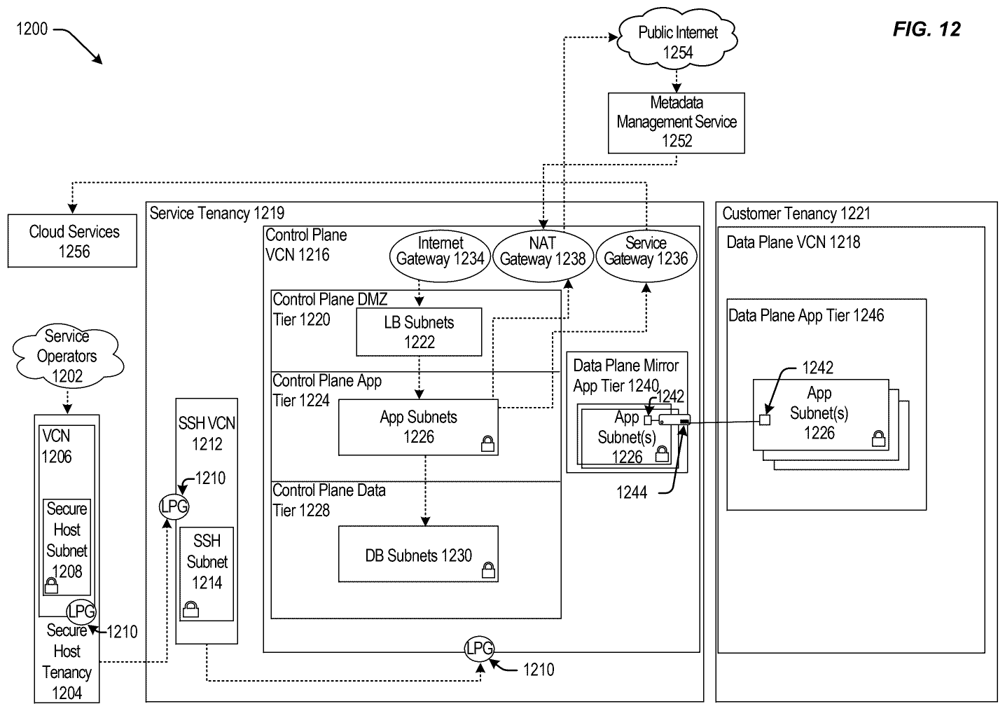

FIG. 12 is a block diagram 1200 illustrating another example pattern of an IaaS architecture, according to at least one embodiment. Service operators 1202 (e.g., service operators 1102 of FIG. 11) can be communicatively coupled to a secure host tenancy 1204 (e.g., the secure host tenancy 1104 of FIG. 11) that can include a virtual cloud network (VCN) 1206 (e.g., the VCN 1106 of FIG. 11) and a secure host subnet 1208 (e.g., the secure host subnet 1108 of FIG. 11). The VCN 1206 can include a local peering gateway (LPG) 1210 (e.g., the LPG 1110 of FIG. 11) that can be communicatively coupled to a secure shell (SSH) VCN 1212 (e.g., the SSH VCN 1112 of FIG. 11) via an LPG 1110 contained in the SSH VCN 1212. The SSH VCN 1212 can include an SSH subnet 1214 (e.g., the SSH subnet 1114 of FIG. 11), and the SSH VCN 1212 can be communicatively coupled to a control plane VCN 1216 (e.g., the control plane VCN 1116 of FIG. 11) via an LPG 1210 contained in the control plane VCN 1216. The control plane VCN 1216 can be contained in a service tenancy 1219 (e.g., the service tenancy 1119 of FIG. 11), and the data plane VCN 1218 (e.g., the data plane VCN 1118 of FIG. 11) can be contained in a customer tenancy 1221 that may be owned or operated by users, or customers, of the system.

The control plane VCN 1216 can include a control plane DMZ tier 1220 (e.g., the control plane DMZ tier 1120 of FIG. 11) that can include LB subnet(s) 1222 (e.g., LB subnet(s) 1122 of FIG. 11), a control plane app tier 1224 (e.g., the control plane app tier 1124 of FIG. 11) that can include app subnet(s) 1226 (e.g., app subnet(s) 1126 of FIG. 11), a control plane data tier 1228 (e.g., the control plane data tier 1128 of FIG. 11) that can include database (DB) subnet(s) 1230 (e.g., similar to DB subnet(s) 1130 of FIG. 11). The LB subnet(s) 1222 contained in the control plane DMZ tier 1220 can be communicatively coupled to the app subnet(s) 1226 contained in the control plane app tier 1224 and an Internet gateway 1234 (e.g., the Internet gateway 1134 of FIG. 11) that can be contained in the control plane VCN 1216, and the app subnet(s) 1226 can be communicatively coupled to the DB subnet(s) 1230 contained in the control plane data tier 1228 and a service gateway 1236 (e.g., the service gateway 1136 of FIG. 11) and a network address translation (NAT) gateway 1238 (e.g., the NAT gateway 1138 of FIG. 11). The control plane VCN 1216 can include the service gateway 1236 and the NAT gateway 1238.

The control plane VCN 1216 can include a data plane mirror app tier 1240 (e.g., the data plane mirror app tier 1140 of FIG. 11) that can include app subnet(s) 1226. The app subnet(s) 1226 contained in the data plane mirror app tier 1240 can include a virtual network interface controller (VNIC) 1242 (e.g., the VNIC of 1142) that can execute a compute instance 1244 (e.g., similar to the compute instance 1144 of FIG. 11). The compute instance 1244 can facilitate communication between the app subnet(s) 1226 of the data plane mirror app tier 1240 and the app subnet(s) 1226 that can be contained in a data plane app tier 1246 (e.g., the data plane app tier 1146 of FIG. 11) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g., the metadata management service 1152 of FIG. 11) that can be communicatively coupled to public Internet 1254 (e.g., public Internet 1154 of FIG. 11). Public Internet 1254 can be communicatively coupled to the NAT gateway 1238 contained in the control plane VCN 1216. The service gateway 1236 contained in the control plane VCN 1216 can be communicatively coupled to cloud services 1256 (e.g., cloud services 1156 of FIG. 11).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources, that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218 but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 11,” may be located in Region 1 and in “Region 2.” If a call to Deployment 11 is made by the service gateway 1236 contained in the control plane VCN 1216 located in Region 1, the call may be transmitted to Deployment 11 in Region 1. In this example, the control plane VCN 1216, or Deployment 11 in Region 1, may not be communicatively coupled to, or otherwise in communication with, Deployment 11 in Region 2.

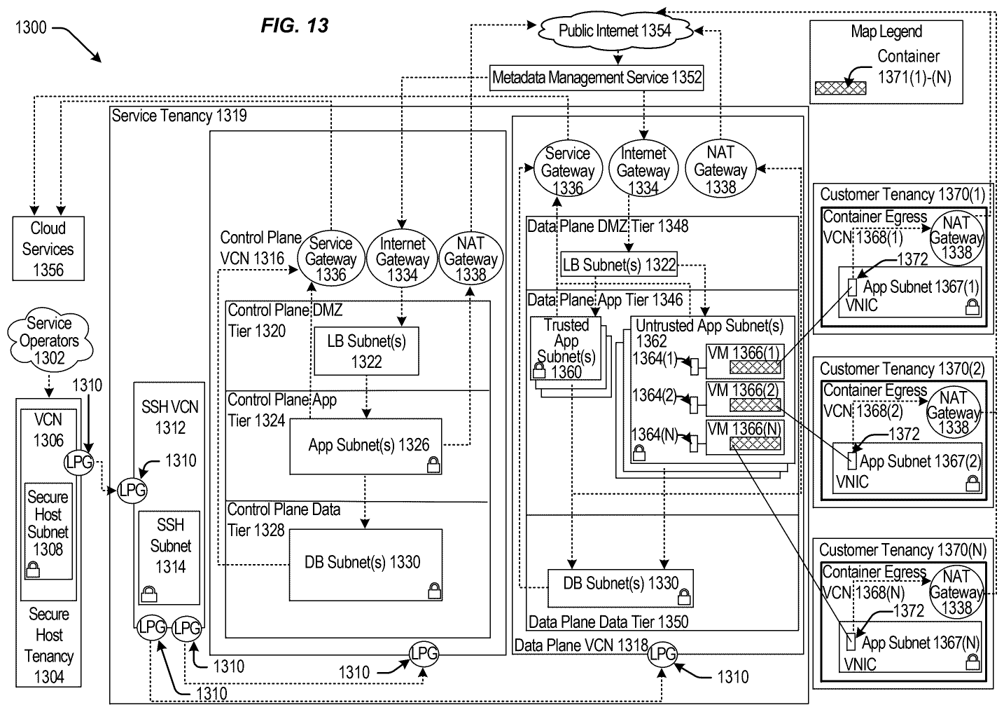

FIG. 13 is a block diagram 1300 illustrating another example pattern of an IaaS architecture, according to at least one embodiment. Service operators 1302 (e.g., service operators 1102 of FIG. 11) can be communicatively coupled to a secure host tenancy 1304 (e.g., the secure host tenancy 1104 of FIG. 11) that can include a virtual cloud network (VCN) 1306 (e.g., the VCN 1106 of FIG. 11) and a secure host subnet 1308 (e.g., the secure host subnet 1108 of FIG. 11). The VCN 1306 can include an LPG 1310 (e.g., the LPG 1110 of FIG. 11) that can be communicatively coupled to an SSH VCN 1312 (e.g., the SSH VCN 1112 of FIG. 11) via an LPG 1310 contained in the SSH VCN 1312. The SSH VCN 1312 can include an SSH subnet 1314 (e.g., the SSH subnet 1114 of FIG. 11), and the SSH VCN 1312 can be communicatively coupled to a control plane VCN 1316 (e.g., the control plane VCN 1116 of FIG. 11) via an LPG 1310 contained in the control plane VCN 1316 and to a data plane VCN 1318 (e.g., the data plane 1118 of FIG. 11) via an LPG 1310 contained in the data plane VCN 1318. The control plane VCN 1316 and the data plane VCN 1318 can be contained in a service tenancy 1319 (e.g., the service tenancy 1119 of FIG. 11).

The control plane VCN 1316 can include a control plane DMZ tier 1320 (e.g., the control plane DMZ tier 1120 of FIG. 11) that can include load balancer (LB) subnet(s) 1322 (e.g., LB subnet(s) 1122 of FIG. 11), a control plane app tier 1324 (e.g., the control plane app tier 1124 of FIG. 11) that can include app subnet(s) 1326 (e.g., similar to app subnet(s) 1126 of FIG. 11), a control plane data tier 1328 (e.g., the control plane data tier 1128 of FIG. 11) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1134 of FIG. 11) that can be contained in the control plane VCN 1316, and the app subnet(s) 1326 can be communicatively coupled to the DB subnet(s) 1330 contained in the control plane data tier 1328 and to a service gateway 1336 (e.g., the service gateway of FIG. 11) and a network address translation (NAT) gateway 1338 (e.g., the NAT gateway 1138 of FIG. 11). The control plane VCN 1316 can include the service gateway 1336 and the NAT gateway 1338.

The data plane VCN 1318 can include a data plane app tier 1346 (e.g., the data plane app tier 1146 of FIG. 11), a data plane DMZ tier 1348 (e.g., the data plane DMZ tier 1148 of FIG. 11), and a data plane data tier 1350 (e.g., the data plane data tier 1150 of FIG. 11). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g., public Internet 1154 of FIG. 11).

The Internet gateway 1334 contained in the control plane VCN 1316 and contained in the data plane VCN 1318 can be communicatively coupled to a metadata management service 1352 (e.g., the metadata management system 1152 of FIG. 11) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively coupled to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

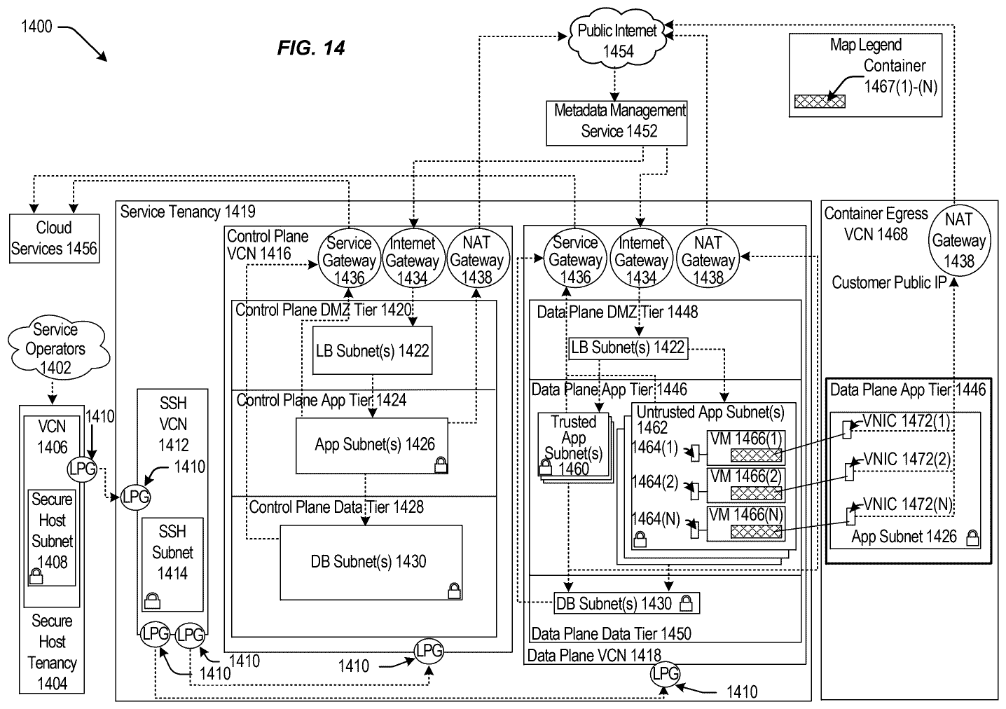

FIG. 14 is a block diagram 1400 illustrating another example pattern of an IaaS architecture, according to at least one embodiment. Service operators 1402 (e.g., service operators 1102 of FIG. 11) can be communicatively coupled to a secure host tenancy 1404 (e.g., the secure host tenancy 1104 of FIG. 11) that can include a virtual cloud network (VCN) 1406 (e.g., the VCN 1106 of FIG. 11) and a secure host subnet 1408 (e.g., the secure host subnet 1108 of FIG. 11). The VCN 1406 can include an LPG 1410 (e.g., the LPG 1110 of FIG. 11) that can be communicatively coupled to an SSH VCN 1412 (e.g., the SSH VCN 1112 of FIG. 11) via an LPG 1410 contained in the SSH VCN 1412. The SSH VCN 1412 can include an SSH subnet 1414 (e.g., the SSH subnet 1114 of FIG. 11), and the SSH VCN 1412 can be communicatively coupled to a control plane VCN 1416 (e.g., the control plane VCN 1116 of FIG. 11) via an LPG 1410 contained in the control plane VCN 1416 and to a data plane VCN 1418 (e.g., the data plane 1118 of FIG. 11) via an LPG 1410 contained in the data plane VCN 1418. The control plane VCN 1416 and the data plane VCN 1418 can be contained in a service tenancy 1419 (e.g., the service tenancy 1119 of FIG. 11).

The control plane VCN 1416 can include a control plane DMZ tier 1420 (e.g., the control plane DMZ tier 1120 of FIG. 11) that can include LB subnet(s) 1422 (e.g., LB subnet(s) 1122 of FIG. 11), a control plane app tier 1424 (e.g., the control plane app tier 1124 of FIG. 11) that can include app subnet(s) 1426 (e.g., app subnet(s) 1126 of FIG. 11), a control plane data tier 1428 (e.g., the control plane data tier 1128 of FIG. 11) that can include DB subnet(s) 1430 (e.g., DB subnet(s) 1330 of FIG. 13). The LB subnet(s) 1422 contained in the control plane DMZ tier 1420 can be communicatively coupled to the app subnet(s) 1426 contained in the control plane app tier 1424 and to an Internet gateway 1434 (e.g., the Internet gateway 1134 of FIG. 11) that can be contained in the control plane VCN 1416, and the app subnet(s) 1426 can be communicatively coupled to the DB subnet(s) 1430 contained in the control plane data tier 1428 and to a service gateway 1436 (e.g., the service gateway of FIG. 11) and a network address translation (NAT) gateway 1438 (e.g., the NAT gateway 1138 of FIG. 11). The control plane VCN 1416 can include the service gateway 1436 and the NAT gateway 1438.

The data plane VCN 1418 can include a data plane app tier 1446 (e.g., the data plane app tier 1146 of FIG. 11), a data plane DMZ tier 1448 (e.g., the data plane DMZ tier 1148 of FIG. 11), and a data plane data tier 1450 (e.g., the data plane data tier 1150 of FIG. 11). The data plane DMZ tier 1448 can include LB subnet(s) 1422 that can be communicatively coupled to trusted app subnet(s) 1460 (e.g., trusted app subnet(s) 1360 of FIG. 13) and untrusted app subnet(s) 1462 (e.g., untrusted app subnet(s) 1362 of FIG. 13) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g., public Internet 1154 of FIG. 11).

The Internet gateway 1434 contained in the control plane VCN 1416 and contained in the data plane VCN 1418 can be communicatively coupled to a metadata management service 1452 (e.g., the metadata management system 1152 of FIG. 11) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively coupled to cloud services 1456.

In some examples, the pattern illustrated by the architecture of block diagram 1400 of FIG. 14 may be considered an exception to the pattern illustrated by the architecture of block diagram 1300 of FIG. 13 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

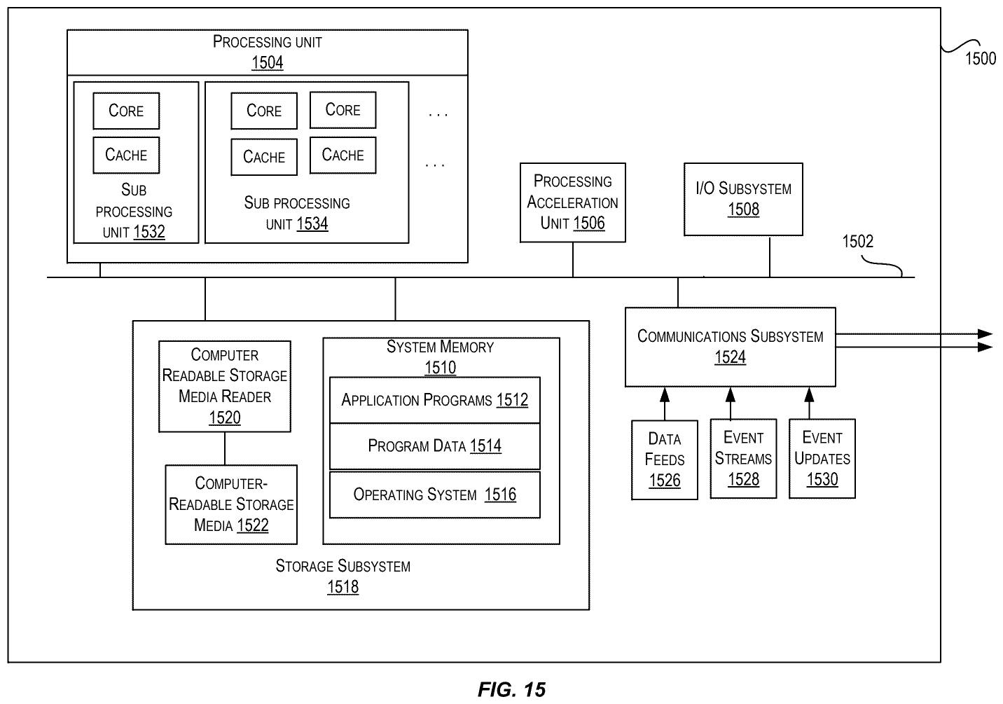

FIG. 15 illustrates an example computer system 1500, in which various embodiments may be implemented. The system 1500 may be used to implement any of the computer systems described above. As shown in the figure, computer system 1500 includes a processing unit 1504 that communicates with a number of peripheral subsystems via a bus subsystem 1502. These peripheral subsystems may include a processing acceleration unit 1506, an I/O subsystem 1508, a storage subsystem 1518 and a communications subsystem 1524. Storage subsystem 1518 includes tangible computer-readable storage media 1522 and a system memory 1510.

Bus subsystem 1502 provides a mechanism for letting the various components and subsystems of computer system 1500 communicate with each other as intended. Although bus subsystem 1502 is shown schematically as a single bus, alternative embodiments of the bus subsystem may utilize multiple buses. Bus subsystem 1502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1504, which can be implemented as one or more integrated circuits (e.g., a conventional microprocessor or microcontroller), controls the operation of computer system 1500. One or more processors may be included in processing unit 1504. These processors may include single core or multicore processors. In certain embodiments, processing unit 1504 may be implemented as one or more independent processing units 1532 and/or 1534 with single or multicore processors included in each processing unit. In other embodiments, processing unit 1504 may also be implemented as a quad-core processing unit formed by integrating two dual-core processors into a single chip.

In various embodiments, processing unit 1504 can execute a variety of programs in response to program code and can maintain multiple concurrently executing programs or processes. At any given time, some or all of the program code to be executed can be resident in processor(s) 1504 and/or in storage subsystem 1518. Through suitable programming, processor(s) 1504 can provide various functionalities described above. Computer system 1500 may additionally include a processing acceleration unit 1506, which can include a digital signal processor (DSP), a special-purpose processor, and/or the like.

I/O subsystem 1508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1500 may comprise a storage subsystem 1518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1504 provide the functionality described above. Storage subsystem 1518 may also provide a repository for storing data used in accordance with the present disclosure.

As depicted in the example in FIG. 15, storage subsystem 1518 can include various components including a system memory 1510, computer-readable storage media 1522, and a computer readable storage media reader 1520. System memory 1510 may store program instructions that are loadable and executable by processing unit 1504. System memory 1510 may also store data that is used during the execution of the instructions and/or data that is generated during the execution of the program instructions. Various different kinds of programs may be loaded into system memory 1510 including but not limited to client applications, Web browsers, mid-tier applications, relational database management systems (RDBMS), virtual machines, containers, etc.

System memory 1510 may also store an operating system 1516. Examples of operating system 1516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1500 executes one or more virtual machines, the virtual machines along with their guest operating systems (GOSs) may be loaded into system memory 1510 and executed by one or more processors or cores of processing unit 1504.

System memory 1510 can come in different configurations depending upon the type of computer system 1500. For example, system memory 1510 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1510 may include a basic input/output system (BIOS) containing basic routines that help to transfer information between elements within computer system 1500, such as during start-up.

Computer-readable storage media 1522 may represent remote, local, fixed, and/or removable storage devices plus storage media for temporarily and/or more permanently containing, storing, computer-readable information for use by computer system 1500 including instructions executable by processing unit 1504 of computer system 1500.

Computer-readable storage media 1522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1522 may include, but is not limited to, Zip® drives, flash memory cards, universal serial bus (USB) flash drives, secure digital (SD) cards, DVD disks, digital video tape, and the like. Computer-readable storage media 1522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1500.

Machine-readable instructions executable by one or more processors or cores of processing unit 1504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1524 provides an interface to other computer systems and networks. Communications subsystem 1524 serves as an interface for receiving data from and transmitting data to other systems from computer system 1500. For example, communications subsystem 1524 may enable computer system 1500 to connect to one or more devices via the Internet. In some embodiments communications subsystem 1524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1524 can provide wired network connectivity (e.g., Ethernet) in addition to or instead of a wireless interface.

In some embodiments, communications subsystem 1524 may also receive input communication in the form of structured and/or unstructured data feeds 1526, event streams 1528, event updates 1530, and the like on behalf of one or more users who may use computer system 1500.

By way of example, communications subsystem 1524 may be configured to receive data feeds 1526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1524 may also be configured to receive data in the form of continuous data streams, which may include event streams 1528 of real-time events and/or event updates 1530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1524 may also be configured to output the structured and/or unstructured data feeds 1526, event streams 1528, event updates 1530, and the like to one or more databases that may be in communication with one or more streaming data source computers coupled to computer system 1500.

Computer system 1500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

1. A method, comprising:
maintaining a project for a target computing system, wherein the project comprises a first integration and a second integration, and wherein the first integration comprises a first revision identifier and the second integration comprises a second revision identifier;
obtaining information indicating that a revision has been made to the first integration;
updating the first revision identifier based at least in part on the revision to the first integration;
determining whether the first integration should be transmitted to the target computing system for use in the project based at least in part on the updated first revision identifier;
responsive to determining that the first integrations should be transmitted to the target system:
generating a container image comprising the first integration; and
transmitting the container image comprising the first integration to the target computing system for implementation within the project of the target computing system;
wherein the method is performed by at least one device including a hardware processor.

2. The method of claim 1, wherein the updated first revision identifier indicates that the revision to the first integration is a major revision.

3. The method of claim 2, wherein the first integration is associated with an endpoint at the target computing system, and wherein the method further comprises:
generating control instructions for the target computing system to disable the endpoint during an installation of the first integration at the target computing system; and
transmitting the control instructions to the target computing system.

4. The method of claim 2, wherein the first integration is associated with a first endpoint at the target computing system, and wherein the method further comprises:
generating control instructions for the target computing system to generate a second endpoint associated with the first integration that indicates the revision to the first integration.

5. The method of claim 1, wherein the updated first revision identifier indicates that the revision to the first integration is a minor revision.

6. The method of claim 5, wherein the first integration is associated with an endpoint at the target computing system, and wherein the method further comprises:
generating control instructions for the target computing system to permit the endpoint to remain enabled during an installation of the first integration at the target computing system; and
transmitting the control instructions to the target computing system.

7. The method of claim 1, wherein the method further comprises:
accessing an indication of a user-based selection of the first integration with the updated first revision identifier, wherein determining whether the first integration is to be transmitted to the target computing system for use in the project is further based at least in part on the user-based selection.

8. The method of claim 1, wherein the first integration comprises a configured integration that is inactive for use at the target computing system or an activated integration that is available for use at the target computing system.

9. The method of claim 1, wherein generating the container image comprises:
accessing metadata describing the first integration that is selected to be in the container image; and
storing the metadata in the container image.

10. The method of claim 1, wherein the method further comprises:
compressing the container image using a compression algorithm, wherein the container image is transmitted in a compressed format.

11. A system comprising:
one or more processors; and
one or more computer-readable media having stored thereon a set of instructions that, when executed by the one or more processors, cause performance of operations comprising:
maintaining a project for a target computing system, wherein the project comprises a first integration and a second integration, and wherein the first integration comprises a first revision identifier and the second integration comprises a second revision identifier;
obtaining information indicating that a revision have been made to the first integration;
updating the first revision identifier based at least in part on the revision to the first integration;
determining whether the first integration is the should be transmitted to the target computing system for use in the project based at least in part on the updated first revision identifier;
responsive to determining that the first integrations should be transmitted to the target system:
generating a container image comprising the first integration; and
transmitting the container image comprising the first integration to the target computing system for implementation within the project of the target computing system.

12. The system of claim 11, wherein the updated first revision identifier indicates that the revision to the first integration is a major revision.

13. The system of claim 12, wherein the first integration is associated with an endpoint at the target computing system, and wherein the operations further comprise:
generating control instructions for the target computing system to disable the endpoint during an installation of the first integration at the target computing system; and
transmitting the control instructions to the target computing system.

14. The system of claim 12, wherein the first integration is associated with a first endpoint at the target computing system, and wherein the operations further comprise:
generating control instructions for the target computing system to generate a second endpoint associated with the first integration that indicates the revision to the first integration.

15. The system of claim 11, wherein the updated first revision identifier indicates that the revision to the first integration is a minor revision.

16. The system of claim 15, wherein the first integration is associated with an endpoint at the target computing system, and wherein the operations further comprise:
generating control instructions for the target computing system to permit the endpoint to remain enabled during an installation of the first integration at the target computing system; and
transmitting the control instructions to the target computing system.

17. The system of claim 11, wherein the operations further comprise:
accessing an indication of a user-based selection of the first integration with the updated first revision identifier, wherein determining whether the first integration is to be transmitted to the target computing system for use in the project is further based at least in part on the user-based selection.

18. The system of claim 11, wherein the first integration comprises a configured integration that is inactive for use at the target computing system or an activated integration that is available for use at the target computing system.

19. One or more non-transitory computer-readable media comprising instructions which, when executed by one or more hardware processors, cause performance of operations comprising:
maintaining a project for a target computing system, wherein the project comprises a first integration and a second integration, and wherein the first integration comprises a first revision identifier and the second integration comprises a second revision identifier;
obtaining information indicating that a revision has been made to the first integration; update the first revision identifier based at least in part on the revision to the first integration;
determining whether the first integration is the should be transmitted to the target computing system for use in the project based at least in part on the updated first revision identifier;
responsive to determining that the first integrations should be transmitted to the target system:
generating a container image comprising the first integration; and
transmitting the container image comprising the first integration to the target computing system for implementation within the project of the target computing system.

20. The one or more non-transitory computer-readable media of claim 19, wherein the operations further comprise:
accessing an indication of a user-based selection of the first integration with the updated first revision identifier, wherein determining whether the first integration is to be transmitted to the target computing system for use in the project is further based at least in part on the user-based selection.
